(19) United States
(12) Patent Application Publication
(10) Pub. No.: US 2004/0093241 A1
(43) Pub. Date: May 13, 2004

(54) Data processing

(76) Inventors: Adrian Stone, Victoria (AU); Robert James Campbell, Victoria (AU)

Correspondence Address: SMITH-HILL AND BEDELL, 12670 N W BARNES ROAD, SUITE 104, PORTLAND, OR, 97229

(21) Appl. No.: 10/468,624

(22) PCT Filed: Feb. 26, 2002
(86) PCT No.: PCT/AU02/00214

(30) Foreign Application Priority Data
Feb. 26, 2001 (AU) PR 3410

(51) Int. Cl. G06F 17/60

(52) U.S. Cl. 705/4

(57) ABSTRACT

An on line data exchange method takes disparate data in disparate formats from parties who are part of a chain in an exchange such as insurers or commodity dealers and selects and translates the data into a common language in order to find data matches capable of resulting in a financial settlement. The method is particularly applicable to handling vehicle insurance claims by selection of Essential Data and seeking matches which indicate a common traffic incident.

### FIELD OF THE INVENTION

The present invention concerns a method for data sharing between companies of similar organisations where multiple payments flow between them.

The invention will be described with particular reference to the vehicle insurance field, but those skilled in the art will see the applicability to fields with similar activity, namely software providers, data matchers and trading exchanges such as stock exchanges.

### BACKGROUND OF THE INVENTION

The interaction between insurance companies, factors, policy holders, repairers and claimants is complex. Much of the work of claims departments is paper based. Transposing clerical errors causes delays in payment. Most of the companies have idiosyncratic processing features, many of which act as a rate determining step or an outright barrier to prompt payments. Simplification arrived when “knock for knock” became acceptable to the industry but this could not deal with all categories of business and is being gradually disbanded.

Accordingly companies inherit legacies of in-house data generation and data handling, but the penalty for having them is slow interfacing with outside companies and much needless human intervention results before payment is made and the claim file is closed. Companies continue to require claims departments which are costly to run. While about 30% of vehicle accidents are straight forward in that they are rear end collisions where there is no dispute even between two insurers, the remainder of the claims are more complex and defy rationalisation into a system which all the parties would trust and then adopt.

### SUMMARY OF THE INVENTION

One aspect of this invention provides a business method of creating compatibility of data exchange between multiple parties, utilising disparate data in disparate formats contributed by the parties, placing the data in a common repository wherein the data is processed to permit automated treatment of data between the parties.

Assuming each party has a legacy system of data handling, the method comprises uploading Essential Data from the legacy systems of the parties to a common processing system, matching the Essential Data in that common processing system and notifying the parties of a match/non-match status.

Preferably the notification is accompanied by the Essential Data. The parties who contribute claims data are the insurers and therefore they receive the match/no-match advice and it is immediately apparent that the two companies are referring to the same accident and the companies can progress to the next stage of the claim.

Preferably the uploading is preceded by conversion of the legacy data to a compatible data for the common processing step via software which translates the legacy data of the insurers into a common compatible language. Extensible Mark Up Language is an example of such translating standard. The establishment of a match may be automatically notified to the insurers. Preferably the notification is accompanied by Essential Data via the same channel which omitted the data from the insurer.

The virtue of the method above lies in that the common format procedure for the disparate data allows for example a traffic incident reported to insurer A is recognised by insurer B as relational to the said traffic incident reported and coded by them in different ways.

The translation stage may include the imposition of a set of codes to render information to each insurer. The codes may be industry standards. The codes may be Relational Incident codes.

Specifically insurer A's incident is hitting a vehicle in the rear. Insurer B's incident is a vehicle suffering a hit in the rear. Making the codes relational allows legacy terms such as HIR (hit in rear) and DAF (driver at fault) to be codified to express one incident as the mirror image of the other allowing the claim to flow to the next step. Thus a traffic incident reported to insurer A is recognised by insurer B as relational to the incident reported and coded by him in a different way. It may be that not all insurers provide legacy code which lends itself to translation into common format in all instances. There may be a prior screening step during which the legacy code is inspected for suitability and sufficiency, eg. needing to specify the point of impact on the vehicle (front, mid or rear).

The match may lead to a settlement decision by the “at fault” insurer. This decision will be subject to Proof of Loss and may be manual or electronic according to insurer selectable parameters. Thereafter either the Settlement Authority or a Request for Further Information—Denial may be generated by the “at fault” insurer.

If accepted the common processing system has automatically settled the claim.

Alternatively if the “at fault” insurer by prior inclusion of parameters, may instruct the common processing system by translation back into the insurers legacy system the information supplied by the “not at fault” insurers Essential Data.

The “at fault” insurer may then make a manual assessment of the incident by inspecting incidental data especially estimated repair costs.

The end of the chain of common processing of the incident which created the claim may be a End-of-Day settlement of all accounts between a pair of insurers. A nett daily balance may be paid from a settlement float, for example a Claims Reserve.

In our co-pending patent application No. ______, we describe a method of processing claims by core method steps which allows notice to be taken of non-standard preferences and idiosyncrasies of procedure which exist among the businesses forming part of the repair chain. This permits data pertaining to the claims to be accessible to the parties for allowing updating and revision.

In the simplest form, the invention provides a data matching method for vehicle insurance claims, comprising comparing data concerning vehicle incidents involving two vehicles, namely the registration numbers of the vehicles, the date of the incident and the individual claim numbers given by the insurers to the incident, and seeking a match in order to indicate that two sets of data refer to the same incident.

Preferably, the data includes the insurers category which classifies the type of incident.

### BRIEF DESCRIPTION OF THE VIEWS OF THE DRAWINGS

Examples of the method are now described with reference to the accompanying drawings:

FIG. 1 shows the prior art scheme;

FIG. 2 shows all the parties in FIG. 1 donating and accepting data to and from the common processor;

FIG. 3 is a diagram showing the translation of data to insurers to mutually compatible form ready for matching; and

FIG. 4 is a diagram of Essential Data ready for order automatic claim settlement.

FIG. 5 is a flow diagram fro an insurance claim.

### DETAILED DESCRIPTION WITH RESPECT TO THE DRAWINGS

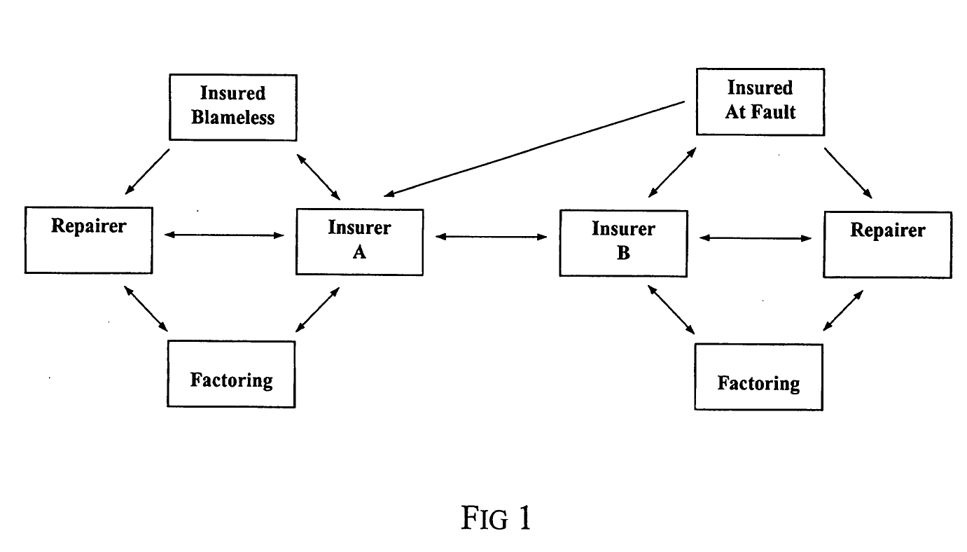

The existing scheme is seen in FIG. 1. A single vehicle accident procedure is as follows:

A claim is lodged with an insurer, who captures certain essential pieces of information into their existing ‘legacy’ computer system. This information would identify, at a minimum:

The insurer's internal unique claim number;

The registration number of their insured's vehicle;

The registration number of any other vehicle involved;

The date of incident;

The insurer's internal coding describing the type of incident;

An indication of the liability of the insurer; and

The cost of repairing their insured's vehicle.

Similarly, the second insurer would identify via their internal computer ‘legacy’ system the above information; however the format and content of certain information will most likely differ due to internal implementation of their systems, for example:

The insurer's internal unique claim number;

The insurer's internal coding describing the type of incident; and

An indication of the liability of the insurer.

However, whilst this information may be of different format and content, the information is related, as they are both records of the same motor vehicle incident albeit from the perspective of their own insured's involvement in the incident.

Also, certain information will be almost identical in content (although the specific format as recorded in each insurer's computer ‘legacy’ system may differ), ie. same content, different format, for example:

The registration number of their insured's vehicle;

The registration number of any other vehicle involved; and

The date of incident.

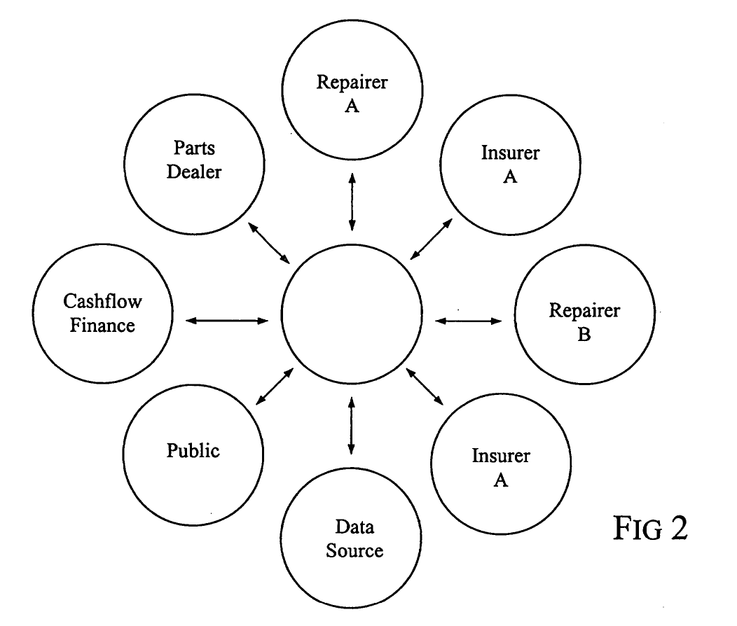

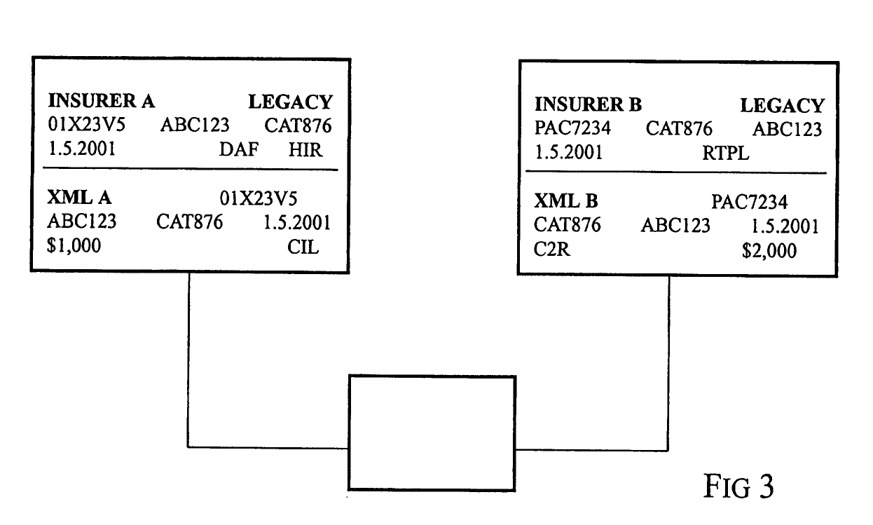

The method exploits these two critical sets of characteristics in order to largely automate a previously manual set of business processes describing the relationship between these two insurers (as described in FIGS. 2 and 3) as follows:

The method supplies a set of standards (in an industry-standard format, eg. XML) for the description of the format of both sets of data, to each participating insurer. Each participating insurer then develops a simple translation routine to convert the aforementioned data items into the standard Essential Data (ie. in XML format) (see FIG. 3).

The Essential Data will contain, at a minimum:

The insurer's internal unique claim number;

The registration number of their insured's vehicle;

The registration number of any other vehicle involved;

The date of incident;

The insurer's internal coding describing the type of incident; and

An indication of the liability of the insurer.

Whilst the content of some data items may still be unique, the format will now be identical, for example:

The insurer's internal unique claim number.

In addition, the method, as part of this translation process, supplies an industry standard set of codes (ie. Relational Incident Codes) to describe information previously of an incompatible form to each insurer, for example:

The insurer's internal coding describing the type of incident; and

An indication of the liability of the insurer.

When two vehicles are involved the paper flow increases to include the following steps:

Preliminary letter of demand

Correspondence to insurer

Company to company advice

Proof of loss to “Insurer B:

Settlement to “Insurer A”

It is also part of the method's translation process that these common pieces of information are now readily shown to relate to the same incident, albeit from the perspective of the insurer of each vehicle according to the information reported to them by the owner of the vehicle.

The method has effectively converted information supplied by each insurer of different content and different format into the Essential Data now of identical format and identical content.

Therefore, the method, now has generated in standard format as a result of this translation process, identical information in terms of content and format (provided that each piece of information was reported correctly by the owner of each vehicle to each insurer), for example:

The registration number of their insured's vehicle;

The registration number of any other vehicle involved; and

The date of incident.

Once this information has been translated by each insurer into the method Essential Data according to the method's unique translation standards, the information is randomly transmitted (in time) by each insurer to the central the method hub where it is randomly stored in the Method Hub's Database.

In the Hub's Database exists a Data Matching system that is now able to examine each Essential Data group as it is transmitted and stored, and compare each group already stored in the current part of the Database.

When the method is used in a trading exchange the commodities may be known by regional names. These are translated into a common language eg. a plant or crop name may be converted to a botanical name. This together with an offering price and a supply date would constitute the Essential data. Claims for medical attention and worker's compensation lend themselves to similar treatment.

Procedure Using the Invention

A claim is lodged with an insurer, who captures certain essential pieces of information into their existing ‘legacy’ computer system. This information would identify, at a minimum:

The insurer's internal unique claim number;

The registration number of their insured's vehicle;

The registration number of any other vehicle involved;

The date of incident;

The insurer's internal coding describing the type of incident;

An indication of the liability of the insurer; and

The cost of repairing their insured's vehicle.

Similarly, the second insurer would identify via their internal computer ‘legacy’ system the above information; however the format and content of certain information will most likely differ due to internal implementation of their systems, for example:

The insurer's internal unique claim number;

The insurer's internal coding describing the type of incident; and

An indication of the liability of the insurer.

However, whilst this information may be of different format and content, the information is related, as they are both records of the same motor vehicle incident albeit from the perspective of their own insured's involvement in the incident.

Also, certain information will be almost identical in content (although the specific format as recorded in each insurer's computer ‘legacy’ system may differ), ie. same content, different format, for example:

The registration number of their insured's vehicle;

The registration number of any other vehicle involved; and

The date of incident.

The method exploits these two critical sets of characteristics in order to largely automate a previously manual set of business processes describing the relationship between these two insurers (as described in diagrams 2 and 3) as follows:

The method supplies a set of standards (in an industry-standard format, eg. XML) for the description of the format of both sets of data, to each participating insurer. Each participating insurer then develops a simple translation routine to convert the aforementioned data items into the method-standard Essential Data (ie. in XML format) (see FIG. 3).

The method's Essential Data will contain, at a minimum:

The insurer's internal unique claim number;

The registration number of their insured's vehicle;

The registration number of any other vehicle involved;

The date of incident;

The insurer's internal coding describing the type of incident; and

An indication of the liability of the insurer.

Whilst the content of some data items may still be unique, the format will now be identical, for example:

The insurer's internal unique claim number.

In addition, the method, as part of this translation process, supplies an industry standard set of codes (ie. Relational Incident Codes) to describe information previously of an incompatible form to each insurer, for example:

The insurer's internal coding describing the type of incident; and

An indication of the liability of the insurer.

When two vehicles are involved the paper flow increases to include the following steps:

It is also part of the method's translation process that these common pieces of information are now readily shown to relate to the same incident, albeit from the perspective of the insurer of each vehicle according to the information reported to them by the owner of the vehicle.

The method has effectively converted information supplied by each insurer of different content and different format into the Essential Data now of identical format and identical content.

Therefore, the method, now has in standard format as a result of this translation process, identical information in terms of content and format (provided that each piece of information was reported correctly by the owner of each vehicle to each insurer), for example:

The registration number of their insured's vehicle;

The registration number of any other vehicle involved; and

The date of incident.

Once this information has been translated by each insurer into the Essential Data according to the method's unique translation standards, the information is randomly transmitted (in time) by each insurer to the central processing stage where it is randomly stored in the Database.

In the Database is a Data Matching System that is now able to examine each data group as it is transmitted and stored, and compare each donated group to ones already stored in the system.

In making this comparison, the method makes use of the fact that certain items within at least two of the Essential Data groups randomly may be identical in content and format, and that if it finds at least two such groups containing certain information which is identical in content and format, the method assumes that the Essential Data relate to the same motor vehicle incident.

The matching of the Essential Data may contain the same information, now in the same content and format for certain items, for example:

The registration number of their insured's vehicle;

The registration number of any other vehicle involved; and

The date of incident.

The method also makes use of the fact that previously incompatible data is now in common format and content to enable the method to effectively automatically decide on the likely outcome of any future litigation between each insurer as to liability for the motor vehicle incident, thus avoiding human interaction or legal involvement.

The method utilises each insurer's own assessment of the incident to see if both agree, for example:

Each insurer's internal coding describing the type of incident; and

Each insurer's indication of the liability of the insurer.

As these ‘matching’ Essential Data now represent each insurer's own assessment of the motor vehicle incident and fall into the method's unique set of Relational Incident Codes, the method system is now easily able to verify whether the Relational Incident Codes for the two matching groups Essential Data are compatible in that they indicate and clearly define the liability of each insurer.

If there is a conflict between any of the information provided in each matching groups, each insurer is notified and they may make use of further use of the method as a means to transmit additional information to the other insurer by means of Standard ACORD Claim Forms and Inter-Company Advices. Presently a three character code suffices to resolve about half of the traffic incidents. A four character code may enlarge this proportion to three quarters

However, where the information is not in conflict, then each insurer agrees that the method has automatically settled the liability aspect of the motor vehicle incident between the parties.

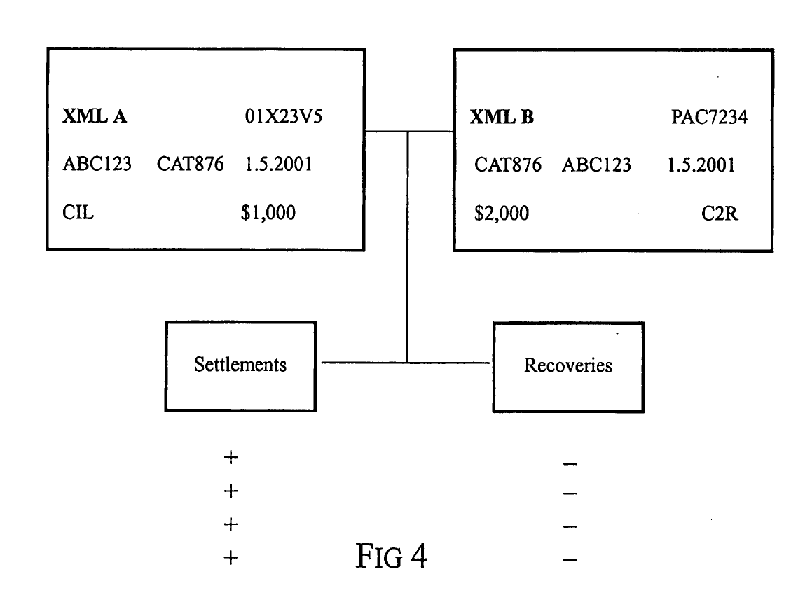

Stage 2—Automatic Settlement (See FIG. 4)

Once liability has been settled by the method, that is a positive match has occurred, additional information as supplied by each insurer can be considered, for example:

The cost of repairing their insured's vehicle.

The method retains a set of parameters supplied by each insurer which allows the method to determine on behalf of each insurer the quantum of one insurer's claim against the other (as already established by the method in deciding liability through the matching of Essential Data).

It is the perogative of the method-determined “At Fault” insurer to decide whether to accept the quantum (ie. ‘the cost of repairing their insured's vehicle’) supplied by the ‘Not at Fault’ insurer according to the information held in their Essential Data, as the ‘At Fault’ insurer will be required by agreement and, ultimately, in law to reimburse the ‘Not at Fault’ insurer that quantum (ie. cost).

Therefore, the method will allow each insurer to set certain parameters within the coding of the method's programs which will allow the method to examine certain information supplied by both insurers, for example:

Each insurer's (translated) coding describing the type of incident; and

The cost of repairing their insured's vehicle.

In addition, the method may include additional information not previously described in the Essential Data to assist the ‘At Fault’ insurer in their assessment of whether to accept quantum, for example:

Insurer's (translated) coding describing the damage to their insured's vehicle; and

A ‘Total Loss Indicator’.

The method is then able to consider this information from both insurers Essential Data and compare that information against the parameters set by prior instruction by the ‘At Fault’ insurer in order to make an automatic assessment on behalf of the ‘At Fault’ insurer as to whether they accept the ‘Not at Fault’ insurer's quantum; if accepted, the method has automatically settled the claim.

Alternatively, the ‘At Fault’ insurer, by prior setting of certain parameters within the coding of the method's programs, may elect to have the method refer (by way of transmission and translation back into the insurer's legacy system) the information supplied in the ‘Not at Fault’ insurer's data.

This will then enable the ‘At Fault’ insurer to make a personal assessment of the information supplied, which may include additional information, for example:

Computer Scanned images of the damaged vehicle supporting the ‘Not at Fault’ insurer's quantum.

Once the ‘At Fault’ insurer manually confirms their position relating to liability and accepts the ‘Not at Fault’ insurer's quantum, they may notify the method of this acceptance by the transmission of the method Acceptance Record at which point, our method is now also able to automatically settle the claim.

The decision for the level of operator intervention required from Nil (ie. settle every claim) to 100% (ie. manually settle every claim) rests, in each case, with the ‘At Fault’ insurer and is set by prior agreement within our method who will adjust the program parameters to reflect each participating insurer's instructions as how they wish their ‘At Fault’ claims to be settled in regard to quantum.

In most cases, the ‘Not at Fault’ insurer's claim in regard to quantum is settled entirely without human intervention. Human intervention merely adds data to enable the work flow to continue.

In each case, each participating insurer's claim, regardless of ‘At Fault’ or ‘Not at Fault’ status, in regard to liability is settled through our method, with minimal human intervention.

In all cases, the method only assumes a match (ie. a valid claim involving two participating insurers) if certain minimum sets of data within a minimum of two groups match in content and format, for example:

The registration number of their insured's vehicle;

The registration number of any other vehicle involved; and

The date of incident.

And, our method only proceeds to settlement, whether automatic settlement or manual settlement, if the Essential Data for each insurer match in relation to certain types of information allowing the method to make an assumption of acceptance of liability by each of the participating insurers involved, for example:

Each insurer's internal coding describing the type of incident; and

Each insurer's indication of the liability of the insurer.

Any other circumstance results in our Exception Report being issued to all participating insurers whose Essential Data have achieved a match but cannot be settled in regard to either liability or quantum, and either automatically or manually settled.

Finally, any Essential Data not achieving a match will result in an Exclusion Report being issued to the insurer who transmitted the data, whereupon the data may be deleted from the system by prior agreement with each participating insurer.

Stage 3—AutoBalance

It is expected that each participating insurer will submit and have settled by most of the claims within an appropriate period of time, expected to be measured in multiples of 1 day.

It is also expected that during each period of time, for each pair of participating insurers that there will be a multitude of incidents where each insurer assumes the role of either ‘At Fault’ or ‘Not at Fault’ insurer.

Therefore, there will be many instances within each period of time for each pair of participating insurers where a payment is made by either of the pair of participating insurers to the other.

It is a further function of the system to calculate, at the end of each period of time, for each participating pair of insurers, the sum of each payment to be made to each insurer less the amount to be received from each insurer.

Rather, than forward each payment to each insurer as they are automatically or manually settled, it is the function of the system to transfer to each insurer the balance of the amount owing after the calculation of the sum of each payment to be made to each insurer less the amount to be received from each insurer, for each pair of participating insurers.

It is expected that each insurer will maintain a Float (ie. a sum of money reasonably expected to cover the amount owning to each other participating insurer at the end of each period of time). The AutoBalance function is used to adjust the amount owing to each participating insurer by each other participating insurer.

At the close of each period of time, the method and each participating insurer would transfer between them the required funds to maintain the Float; this may mean that additional funds are transmitted by the insurer to the system, or that the method transfers a surplus of funds held in excess of the method Float to the insurer (see FIG. 4).

The sum required to be maintained as the Float that is required for the AutoBalance function is expected to be far less than the amount that would otherwise be required by each participating insurer to accommodate the total amount of payments that would otherwise need to be made to each other insurer outside the system.

Also, each participating insurer gains the immediate benefit (ie. at the close of each period of time) of the amounts deeded as owing according to the method from each other participating insurer.

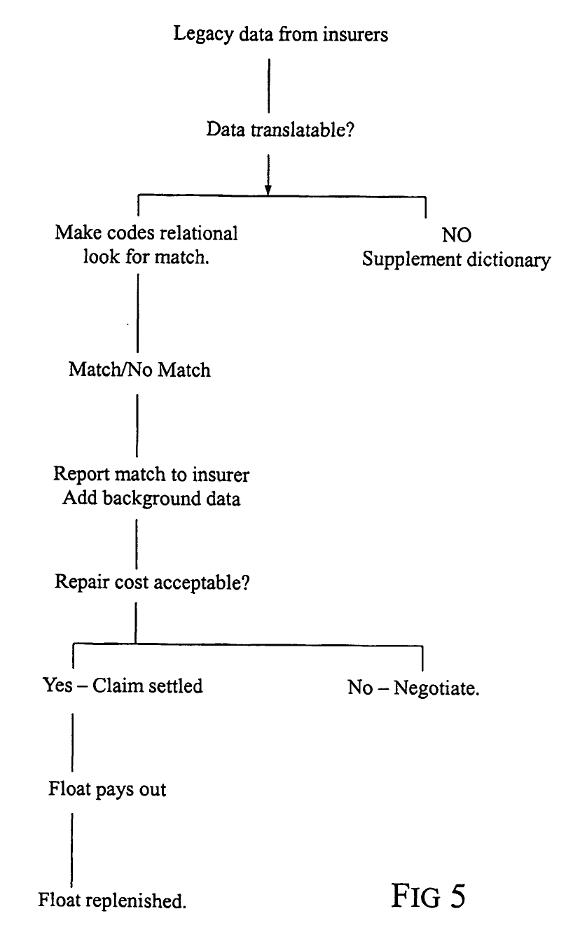

The sequence is shown in event stages in FIG. 5.

We have found the advantages of the above examples to be:

(1) Automated company to company advice;

(2) More rapid payments leading to customer satisfaction and retention; and

(3) Fraud detection by data mining.

The claims, illustrations, photographs and drawings, if any, form part of the disclosure of this specification as does the description, claims, illustrations, photographs and drawings of any associated provisional or parent specification or of any priority document, if any, all of which are imported hereinto as part of the record hereof

Finally it is to be understood that various alterations, modifications and/or additions may be incorporated into the various constructions and arrangements or parts without departing from the spirit and ambit of the invention.

The claims defining the invention are as follows:

1. A method of creating compatability of data exchange between multiple parties comprising:
utilising disparate data in disparate formats contributed by the parties;
placing the data in a common repository in order to permit automated treatment of the data between the parties.

2. A data exchange method comprising admitting essential data donated by the parties to a common processing procedure, seeking matches in the essential data and notifying the parties of a match.

3. An on line data exchange method for data donated by two or more parties comprising admitting essential data donated by the parties, converting the essential data of the parties to a common language and seeking a match between donated data.

4. An on line data exchange method as claimed in claim 3 wherein the essential data is legacy data from a donating party and is converted to common language by Extensible Mark Up language.

5. An on line data exchange method as claimed in claim 4 wherein the conversion is preceded by a screening step which checks for an omission in the essential data.

6. An on line data exchange method as claimed in any one of claims 3 to 5 wherein the establishment of a match causes notification to the relevant parties.

7. An on line data exchange method as claimed in claim 6 wherein the notification is accompanied by provision of supplementary data to add a detail to the exchange.

8. An on line data exchange method as claimed in claim 7 wherein the supplementary data includes the essential data from the donating parties.

9. An on line data exchange method as claimed in claim 7 or 8 wherein supplementary data includes a price.

10. An on line data exchange method as claimed in any one of claims 6 to 9 wherein the supplementary data is sent to the parties by the same channel used to collect the donated data.

11. An on line data exchange method as claimed in any one of claims 2 to 10 wherein the notification of a match is followed by an operator's appraisal and a decision to transmit on the basis of the match and optionally the price.

12. An on line data exchange method substantially as herein described.

13. An on line insurance claim settling method comprising:
uploading essential data from parties who contributed data concerning the claim,
converting the data to a mutually compatible form which enables the comparison,
searching for a match in order to identify an incident common to two parties which is the subject of the claim.

14. An on line insurance claim settling method as claimed in claim 13 followed by notification of two parties concerned in the incident.

15. An on line insurance claim settling method as claimed in claim 13 or 14 wherein the essential data comprises the date of the incident, the registration number of a first vehicle; the registration number of a second vehicle, and the type of incident.

16. An on line insurance claim settling method as claimed in any one of claims 13 to 15 wherein the type of incident is expressed in a compatible form wherever the two parties refer to the same type of incident by a different code.

17. An on line insurance claim settling method as claimed in any of claims 13 to 15 wherein any one party refers to an incident type by their code and another party refers to the same incident type by a different code, the codes are equated before a comparison is made.

18. An on line insurance claim settling method as claimed in claim 14 wherein notification is accompanied by the essential data.

19. An on line insurance claim settling method as claimed in claim 17 wherein the notification is accompanied by supplementary data which assists the parties in assessing their claim position.

20. An on line insurance claim settling method as claimed in claim 16 wherein the supplementary data includes a repair estimate from the party NOT AT FAULT for the party AT FAULT.

21. An on line insurance claim settling method as claimed in claim 19 wherein when a party accepts the estimate, the claim is notionally settled and a debit/credit adjustment is made between the accounts of the parties.

22. An on line insurance claim settling method as claimed in Claim 20 wherein periodic transfers of money are made between the accounts of the parties to reestablish an agreed float quantum.

23. An on line insurance claim settling method substantially as herein described.

24. A data matching method for vehicle insurance claims comprising comparing data concerning vehicle incidents involving two vehicles, namely the registration numbers of the vehicles, the date of the incident and the individual claim numbers given by the insurers to the incident, and seeking a match in order to indicate that two sets of data refer to the same incident.

25. A data matching method as claimed in claim 23 wherein the data includes the insurers category which classifies the type of incident.
